(19) United States
(12) Patent Application Publication
(10) Pub. No.: US 2012/0216104 A1
(43) Pub. Date: Aug. 23, 2012

(54) SYSTEM AND METHOD FOR PREPARING EXCEL(TM)-BASED ANALYSIS REPORTS

(75) Inventor: Young-geun Bae, Seoul (KR)

(73) Assignee: BI MATRIX CO., LTD., Seoul (KR)

(21) Appl. No.: 13/504,789

(22) PCT Filed: Oct. 29, 2010
(86) PCT No.: PCT/KR2010/007530

§ 371 Date: Apr. 27, 2012

(30) Foreign Application Priority Data
Oct. 30, 2009 (KR) 10-2009-0104450

(51) Int. Cl. G06F 17/21

(52) U.S. Cl. 715/212

(57) ABSTRACT

The invention relates to a system and method for preparing Excel™-based analysis reports, which involve processing basic data stored in a database and preparing analysis reports or a screen on the basis of the Excel™ program.

The system and method takes an SQL sentence for a database from a user; generates a DB object for the sentence; generates a pivot table cache on the basis of the DB object; and receives an Excel™ display object prepared by the user, wherein data referenced by the Excel™ display object are dependent on the pivot table cache; and generates meta-information for a report, containing the Excel™ display object and the DB object.

According to the invention, users may prepare reports using the Excel™ well-known to office workers. Thus, users may easily extract necessary information from the database, and prepare reports and online analytical processing (OLAP) screens having various formats.

### RELATED APPLICATIONS

This application claims priority to and the benefit of Korean Patent Application No. 10-2009-0104450 filed on Oct. 30, 2009, the disclosure of which is incorporated herein by reference in its entirety.

This application also claims priority to and the benefit of PCT/KR2010/007530 filed on Oct. 29, 2010, the disclosure of which is incorporated herein by reference in its entirety.

### BACKGROUND

In general, business intelligence (BI) refers to a series of tools that support for more reasonable business by analyzing vast amounts of data of an enterprise by formal methods such as statistical analysis or by informal methods to process the analyzed information in the form of a report which is easy to read and understand.

There is a large amount of data accumulated in the business of an enterprise. Such data provide live information about business fields. If the data are properly analyzed, information required for the business can be extracted from the data. However, it is not easy to obtain meaningful analysis results from the large amount of data accumulated in the fields.

Many tools have been individually developed for such an analysis. For example, typical tools include a data extraction and transformation tool, an on-line analytical processing (OLAP) tool for multi-dimensional data analysis, a reporting tool for preparing reports, a data mining tool for discovering a hidden relationship between data, etc. When this series of tools are formed into a software product group, it corresponds to a kind of BI.

However, while the conventional BIs are provided with various analysis tools, users should have experienced knowledge to manipulate various analysis tools, and thus the conventional BIs were difficult to use universally except for a specific analysis.

To overcome the aforementioned problems, a reporting technique for analysis by querying a database in a web environment is disclosed, for example, in Korean Patent No. 10-0497800 (published on Jun. 18, 2005, titled “Reporting system linked with web environment”) (hereafter, referred to as prior art 1). A client/server reporting system of prior art 1 comprises a database server composed of RDBMS and a data warehouse; a developer computer provided with a developer reporting tool which designs a report using data of the database server with WYSIWYG and Drag & Drop functions; a web server provided with a web reporting server which registers the report designed by the developer reporting tool, reads data required by the database server based on the content of the corresponding report in response to a report output request from a user computer, generates the report, and then transmits the report to the user computer; and the user computer provided with a web browser which accesses the web server and requests the output of the report.

That is, prior art 1 relates to a technique in which the report developer designs the frame of the report and the user requests the output of the report depending on the designed frame of the report. Here, according to prior art 1, the developer may design the frame of the report with WYSIWYG and Drag & Drop functions. In detail, the frame of the report may be designed with 4th generation language (4GL), and Visual Basic, Delphi, PowerBuilder, etc. may be used.

Therefore, according to prior art 1, the developer has to learn a reporting tool or a language in order to design the frame of the report, which is problematic. Although the WYSIWYG programming language such as PowerBuilder or a development tool is easier to learn compared with other tools, it is unfamiliar to general office workers. For these reasons, the introduced reporting tools for the BI are not well used by the business employees, especially, small business employees.

Thus, there exists in fee art a need to overcome these problems and, as will be seen, the invention does this in an elegant manner.

### BRIEF DESCRIPTION OF DRAWINGS

FIG. 1 is a diagram showing fee configuration of fee entire system for implementing a system and method for preparing an Excel™-based analysis report in accordance with fee invention.

FIG. 2 is a block diagram showing fee configuration of a system for preparing an Excel™-based analysis report in accordance with an embodiment of the invention.

FIG. 3 is a diagram showing an example of a screen of art SQL generator in accordance with the embodiment, FIG. 4 is a diagram showing an example of an SQL sentence in accordance with the embodiment.

FIG. 5 is a diagram showing an example of a screen of a report preparation system in accordance with the embodiment.

FIG. 6 is a diagram showing art example in which a control-box shaped cell on an Excel™ spreadsheet is used as a condition object of a DB object in accordance with the embodiment.

FIG. 7 is a diagram showing an example of a screen generated by a report viewer in accordance with the embodiment.

FIG. 8 is a flowchart showing a method for preparing an Excel™-based analysis report in accordance with another embodiment.

### DETAILED DESCRIPTION

The invention is directed to solve the above-described problems. In one embodiment, a spreadsheet Excel™-based analysis report such as one based on Microsoft Excel™ for example, is provided that prepares an analysis report or a screen based on an Excel™ spreadsheet by processing basic data stored in a database.

Another embodiment provides a system and method for preparing Excel™ a spreadsheet-based analysis report such as one based on Microsoft Excel™ for example, that generates a database (DB) object corresponding to an SQL sentence for querying a database, links the DB object to a pivot table cache of an Excel™ spreadsheet, and supports the preparation of a pivot table or a chart object on the Excel™ spreadsheet based on the pivot table cache.

Yet another embodiment provides a system and method for preparing an spreadsheet Excel™-based analysis report such as one based on Microsoft Excel™ for example that generates report meta-information including a generated DB object and a prepared Excel™ display object, the report meta-information being readable by a report viewer.

In one example, a system is provided for preparing an Excel™-based analysis report, which prepares an analysis report presented as an Excel™ display object by processing basic data stored in a database (DB), the system comprising: a DB object generating unit which receives an SQL sentence for querying the DB from a developer and generates a DB object for the SQL sentence; a cache-generating unit which generates a pivot table cache based on the DB object; a display object preparing unit which generates an Excel™ spreadsheet and receives an Excel™ display object on the generated Excel™ spreadsheet from the developer, in which data referenced by the Excel™ display object is based on the pivot table cache; and a meta-information generating unit which generates report meta-information including the prepared Excel™ display object and the DB object, in which the DB object may include the SQL sentence and include a DB table queried by the SQL sentence or a function to query the SQL sentence.

The DB object generating unit may provide an SQL generator for querying the DB and receive the SQL sentence generated by the SQL generator.

The display object preparing unit may implement the generation of the Excel™ spreadsheet and the preparation of the Excel™ display object by linking to Excel™ functions.

The display object preparing unit may prepare a pivot table and a chart object as the Excel™ display object, the pivot table may be prepared based on the pivot table cache, and the chart object may be prepared based on the pivot table.

The DB object may query the database from a DB server connected to a network via a WAS server.

The DB object generating unit may determine a variable value of the SQL sentence of the DB object as an object value of a condition object on the Excel™ spreadsheet, and the condition object may be a cell or a control.

The DB object generating unit may identify the condition object by a name, and the DB object may determine the object value of the cell or the control as a variable value when the variable value of the SQL sentence is the same as the name of the condition object.

A row source of the condition object may be composed of the DB object including the SQL sentence, and one of data queried by the row source DB object may be selected as the object value of the condition object.

The report meta-information may include the DB object, the condition object, and the Excel™ display object, the condition object may include the position of the condition object and the row source DB object, and the Excel™ display object may include the position of the display object and an attribute value of the display object.

In another example, a method is provided for preparing an Excel™-based analysis report, which prepares an analysis report presented as an Excel™ display object by processing basic data stored in a database (DB), the method comprising: (a) receiving an SQL sentence for querying the DB from a developer and generating a DB object for the SQL sentence; (b) generating a pivot table cache based on the DB object; (c) generating an Excel™ spreadsheet and receiving an Excel™ display object on the generated Excel™ spreadsheet from the developer, in which data referenced by the Excel™ display object is based on the pivot table cache; and (d) generating report meta-information including the prepared Excel™ display object and the DB object, in which the DB object may include the SQL sentence and include a DB table queried by the SQL sentence or a function of querying the SQL sentence.

In step (c), a pivot table and a chart object may be prepared as the Excel™ display object, the pivot table may be prepared based on the pivot table cache, and the chart object may be prepared based on the pivot table.

In step (a), a variable value of the SQL sentence of the DB object may be determined as an object value of a condition object on the Excel™ spreadsheet, and the condition object may be a cell or a control.

In step (a), the condition object may be identified by a name, and the DB object may determine the object value of the cell or the control as a variable value when the variable value of the SQL sentence is the same as the name of the condition object.

A row source of the condition object may be composed of the DB object including the SQL sentence, and one of data queried by the row source DB object may be selected as the object value of the condition object.

In still another embodiment, there is provided a computer-readable recording storing a program for performing the method for preparing an Excel™-based analysis report.

As described above, according to the system and method for preparing an Excel™-based analysis report in accordance with the one embodiment, a report may be prepared based on an Excel™ spreadsheet which is familiar to office workers, and thus it is possible to easily prepare various types of reports and online analytical processing (OLAP) screens by easily extracting necessary information from the data stored in the database.

Moreover, according to the system and method for preparing an Excel™-based analysis report, a database (DB) object corresponding to an SQL sentence for querying a database may be generated and linked to a pivot table cache of an Excel™ spreadsheet, and thus it is possible to enhance the linkage and compatibility between the DB and the Excel™ and to maximize the utilization of Excel™ functions.

Furthermore, according to the system and method for preparing an Excel™-based analysis report, report meta-information including the generated DB object and the prepared Excel™ display object may be generated such that another user may view the prepared report through a simple viewer.

### MODE FOR INVENTION

Hereinafter, preferred embodiments in accordance with the invention will be described with reference to the accompanying drawings.

Moreover, in the description of the invention, the same elements are denoted by the same reference numerals, and their description will be omitted.

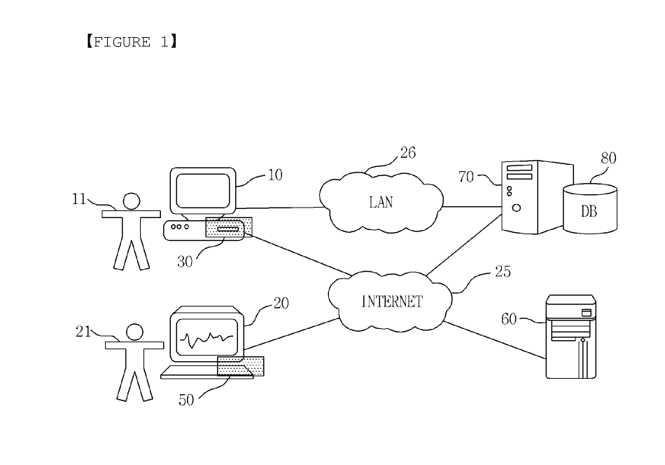

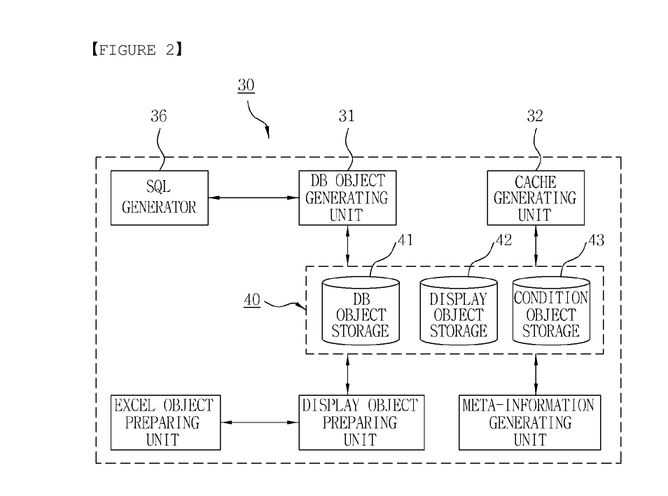

First, the configuration of the entire system for implementing a system and method for preparing an Excel™-based analysis report in accordance with the invention will be described with reference to FIG. 1.

As shown in FIG. 1, the entire system for implementing the invention comprises a developer terminal 10, a report preparation system 30, a database (DB) server 70 and a database 80. Additionally, the system may further comprise a user terminal 20, a report viewer 50 and a WAS server 60.

Meanwhile, the system may further comprise a LAN 26 for allowing the developer terminal 10 to directly connect to the DB server 70. The developer terminal 10, the DB server 70, and the WAS server 60 may be connected to an Internet 25 such that the developer terminal 10 may access the DB 80 via the WAS server 60. Moreover, the report viewer 50, the WAS server 60, and the DB server 70 may be connected to the Internet 25 such that the report viewer 50 may access the DB 80 via the WAS server 60.

The developer terminal 10 corresponds to a typical computing device used by a developer 11. An example of the developer terminal 10 may include a PC, a PDA, a mobile terminal, etc. The configuration and operating principle of the developer terminal 10 are publicly known and commonly used in the art, and thus the detailed description thereof will be omitted. The report preparation system 30 is installed in the developer terminal 10 and executed by the report preparation system 30 to prepare a report.

The user terminal 20 corresponds to a typical computing device used by a user 21. An example of the user terminal 20 may include a PC, a PDA, a mobile terminal, etc. like the developer terminal 10. The report viewer 50 is installed in the user terminal 20 and executed by the user 21 to allow the user 21 to view the report.

The DB 80 stores various data. DB operations such as access, update, addition, deletion, etc. are performed by the DB server 70. The DB server 70 and the DB 80 may have a more structural configuration like a data warehouse.

The report preparation system 30 is installed in the developer terminal 10 to support the preparation of a report. The report preparation system 30 is connected to the DB server 70 via the LAN 26 or the Internet 25 to query the DB 80. The developer 11 creates an SQL sentence to extract desired data using the report preparation system 30. The report preparation system 30 generates a DB object which may refer to the DB 80 depending on the SQL sentence created by the developer 11.

Moreover, the report preparation system 30 supports the preparation of an Excel™ display object on an Excel™ spreadsheet based on the queried DB 80. The Excel™ display object includes a pivot table, a table, a chart, etc. The original data (or basic data) of the pivot table and the table are given by the previously generated DB object. The original data of the chart and the like is data of the pivot table or the table. The report preparation system 30 is implemented by linking to Excel™ functions such that the developer 11 may prepare the Excel™ display object in the same way as the operation performed on the Excel™ spreadsheet.

Furthermore, the report preparation system 30 stores the DB object, the Excel™ display object, etc., which are generated by the developer 11 as meta-information. The stored meta-information is shown to the user 21 through the report viewer 50. That is, when the developer 11 prepares a report using the report preparation system 30, the user 21 views the prepared report through the report viewer 50.

The report viewer 50 serves to decrypt the meta-information and display the content of the prepared report as it is on an Excel™ spreadsheet. The meta-information includes the DB object, the Excel™ display object, etc. The report viewer 50 shows the report by displaying the Excel™ display object on the Excel™ spreadsheet using the meta-information of the Excel™ display object. Moreover, the report viewer 50 may access the DB 80 through the DB object to bring the data of the report on-line.

Meanwhile, the WAS server 60 is a kind of a web application server which provides an access service to the DB 80. For example, when the report viewer 50 requests the database query from the WAS server 60 through the DB object, the WAS server 60 requests the database reference by the SQL sentence from the DB server 70 using the SQL sentence received from the DB object. Then, the WAS server 60 returns the reference results received from the DB server 70 to the DB object.

Although the foregoing description provides an example in which the report preparation system 30 accesses the DB server 70 directly through the LAN 26, the report preparation system 30 may be configured to access the DB server 70 indirectly through the WAS server 60.

Since the WAS server 60 dedicatedly provides the access

service to the DB 80, there is an advantage of providing a higher-level data service such as security and the like. For example, the WAS server 60 may receive a request from the DB object and verify or certify whether the request from the DB object is valid or not. The WAS server 60 may perform encryption communication with the DB server 70. That is, the WAS server 60 may process the service request for the DB 80 through the encryption communication under reinforced security policies.

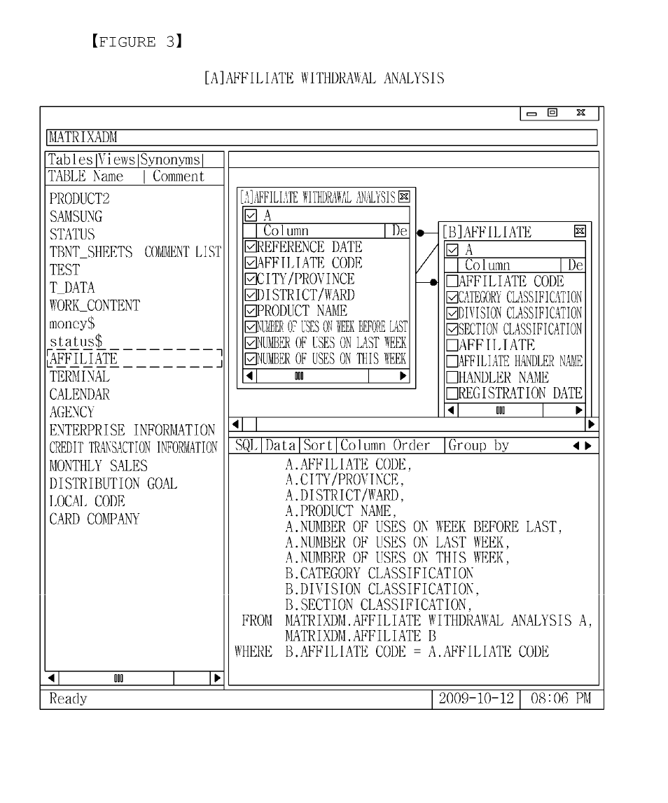

Next, the configuration of a system for preparing an Excel™-based analysis report in accordance with an embodiment will be described with reference to FIG. 2.

As shown in FIG. 2, the report preparation system 30 comprises a DB object generating unit 31, a cache generating unit 32, a display object preparing unit 33 and a meta-information generating unit 34. Moreover, the report preparation system 30 may comprise an SQL generator 36 or an Excel™ object preparing unit 37 or may be configured to link to the SQL generator 36 or the Excel™ object preparing unit 37.

The DB object generating unit 31 receives an SQL sentence for querying the DB 80 from the developer 11 and generates a DB object of the SQL sentence. Preferably, the DB object generating unit 31 provides the SQL generator 36 for querying the DB 80 and receives the SQL sentence generated by the SQL generator 36.

The SQL generator 36 provides information on DB tables present in the DB 80 and fields within the DB tables. Preferably, the SQL generator 36 provides a screen to generate the SQL sentence in a WYSIWYG manner and a Drag & Drop manner.

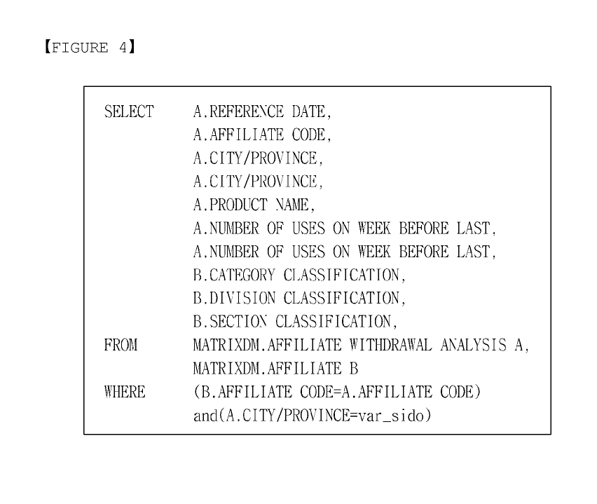

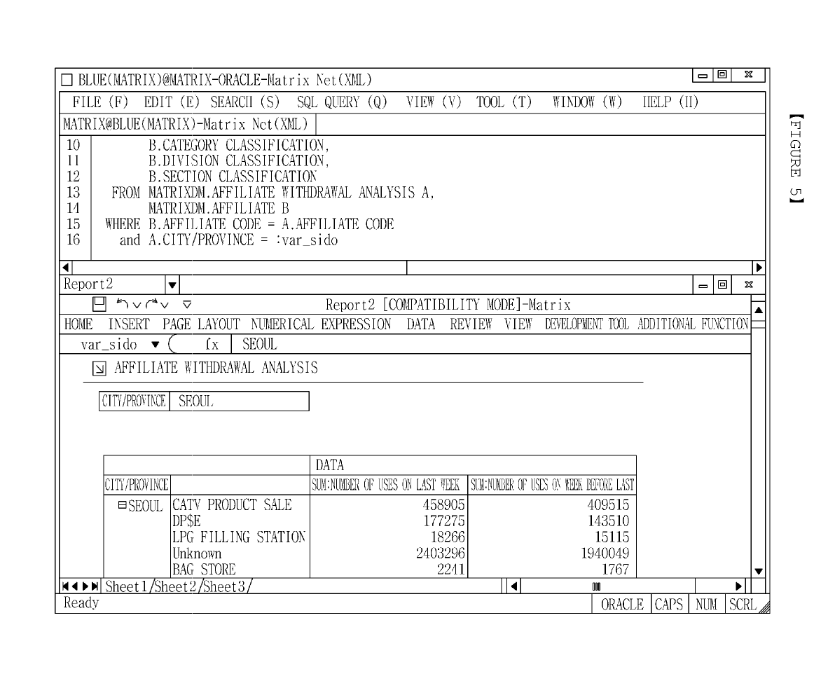

As an example, as shown in FIG. 3, the SQL generator 36 shows a list screen of the DB tables present in the DB and field names within the DB tables and provides a screen for establishing a relationship between the DB tables, an SQL generation screen, etc.

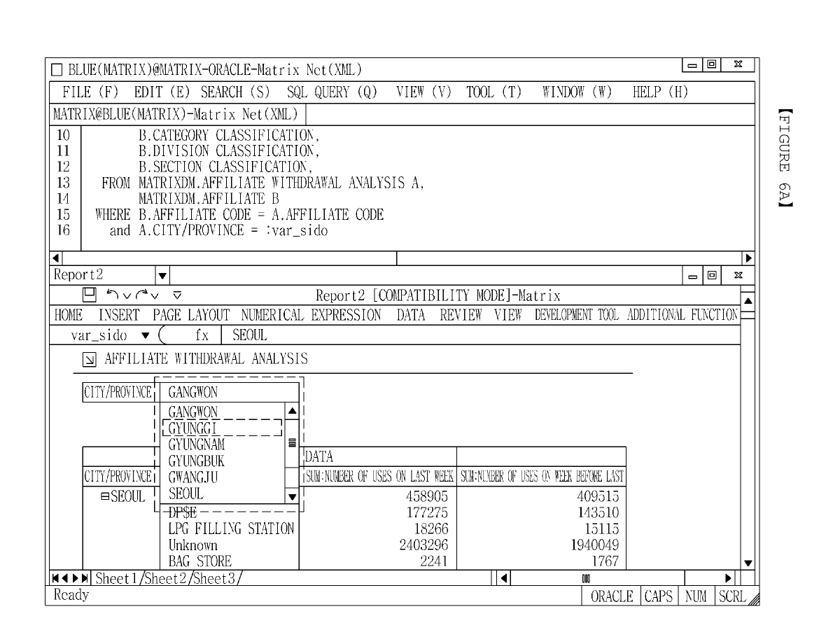

As another example, as shown in FIG. 5, the SQL generator 36 is located at the top of the Excel™ object preparing unit 37 and provides a screen through which the SQL sentence can be directly input.

An example which is finally generated by the SQL generator 36 is an SQL sentence shown in FIG. 4.

Meanwhile, the DB object generating unit 31 may include the SQL generator 36 therein or may link to an external SQL generator.

The DB object generating unit 31 receives the SQL sentence generated by the SQL generator 36 and generates the DB object of the SQL sentence. The DB object includes the SQL sentence and includes the DB table queried by the SQL sentence or a function to query the SQL sentence.

The DB object is an object having attributes and functions. Particularly, the DB object has a function to perform DB operations such as access, query, modification, deletion, addition, etc. and may have the queried DB tables (or DB data).

Preferably, The DB object is implemented using a DB object interface model such as ActiveX Data Object (ADO), Data Access Object (DAO), Remote Data Object (RDO), etc. The DB object model provides an interface through which the DB operations can be performed by accessing the DB server 70.

The cache generating unit 32 generates a pivot table cache based on the DB object. The display object preparing unit 33 generates an Excel™ spreadsheet and receives the Excel™ display object on the generated Excel™ spreadsheet from the developer. The data referenced by the Excel™ display object is based on the pivot table cache.

The cache generating unit 32 and the display object preparing unit 33 are implemented by linking to the Excel™ functions. As mentioned above, the report preparation system 30 is a software tool may be installed in the developer terminal 10. The Excel™ may also be installed in the developer terminal 10. Typically, while the Excel™ has its own window screen, the report preparation system 30 processes the Excel™ screen in its own single screen by linking to the Excel™ functions as shown in FIG. 5.

That is, the display object preparing unit 33 implements the generation of the Excel™ spreadsheet and the preparation of the Excel™ display object by linking to the Excel™ functions. The linkage is performed using the interface functions of the Excel™.

The caches generated based on the DB object by the cache generating unit 32 include a general table and a pivot table. They are all tables similar to each other, and thus the table and the pivot table will be referred to as a pivot table below. That is, unless otherwise mentioned, the pivot table refers to both the table and the pivot table.

The pivot table cache is a temporary data set for generating the pivot table. The data source of the pivot table generated on the Excel™ spreadsheet is data in the pivot table cache.

The display object preparing unit 33 generates the Excel™ spreadsheet. The Excel™ display objects generated by the display object preparing unit 33 are all displayed on the Excel™ spreadsheet. The Excel™ display object includes the pivot table (including the table), the chart, etc. The original data (or basic data) of the pivot table is determined by the pivot table cache. That is, it may be considered that the original data is ultimately determined by the DB object. The original data of the chart and the like is the data of the pivot table (or the table).

Meanwhile, the DB object generating unit 31 may determine a variable value of the SQL sentence of the DB object as an object value of a condition object on the spreadsheet. The condition object is a cell or a control. As shown in FIG. 4, the SQL sentence is composed of a SELECT sentence in which a field name to be extracted is stated, a FROM sentence in which a DB table name to be queried is stated, and a WHERE sentence which shows conditions.

The condition sentence (or the WHERE sentence) represents the condition by a numerical expression. The numerical expression is composed of variables and variable values. For example, when a condition in which a grade is equal to or higher than 60 is represented by a numerical expression, the numerical expression is “grade>=60”. Here, the “grade” is a variable and “60” is a variable value. The variable value of “60” may be determined as an object value of a condition object on the Excel™ spreadsheet, instead of a constant.

As shown in FIG. 4, there is a condition sentence including a condition expression “A. City/Province=var_sido”. As shown in FIG. 5, the “var_sido” of the condition expression is a name of the condition object on the Excel™ spreadsheet, that is, a name of a cell having a cell value of “Seoul” of the Excel™ spreadsheet. The cell value of the cell “var_sido” corresponds to a variable value of the “var_sido” of the condition expression. In FIG. 5, if the cell value of the cell “var_sido” is “Daejeon” instead of “Seoul”, the condition expression of the SQL sentence of FIG. 4 will be “A. City/Province=‘Daejeon’”.

Preferably, the DB object generating unit 31 identifies the condition object by a name, and the DB object determines the object value of the cell or the control as the variable value when the variable value of the SQL sentence is the same as the name of the condition object.

Meanwhile, a row source of the condition object may be composed of the DB object including the SQL sentence. One of data queried by the row source DB object may be selected as the object value of the condition object.

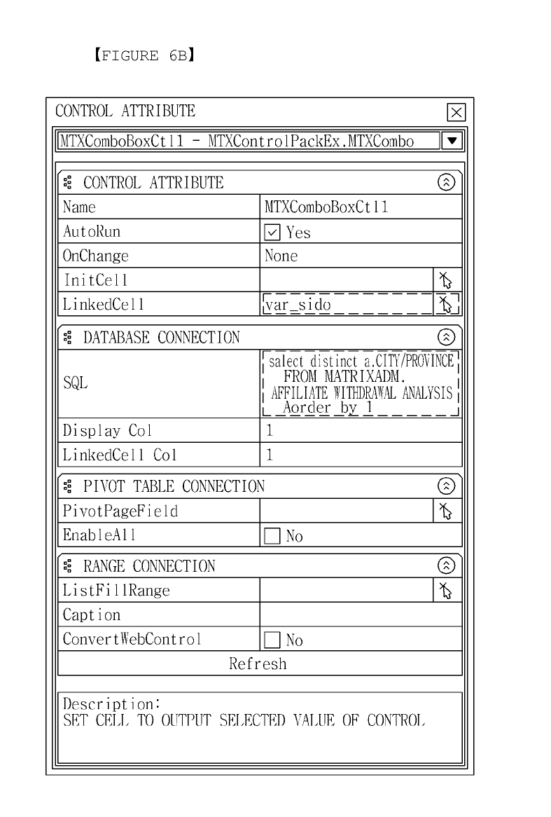

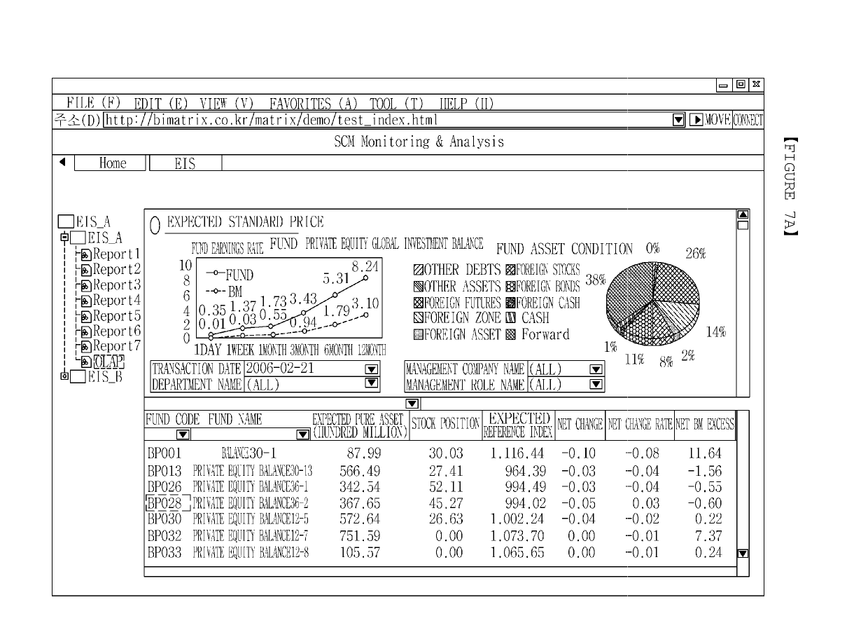

As shown in FIG. 6A, the condition object on the Excel™ spreadsheet may be implemented by a control such as a combo box, a list box, etc. Here, the combo box or the list box has a plurality of rows. One of the rows is selected and the value of the selected row corresponds to the object value of the condition object. Here, the original data of the row may be defined by the SQL sentence. Preferably, the row source of the condition object is linked to the DB object generated by the SQL sentence.

As shown in FIG. 6B, the report preparation system 30 generates a control, connects the generated control to the cell of “var_sido”, and connects the row source of the control to the DB object of the SQL sentence.

Lastly, the meta-information generating unit 34 generates report meta-information including the prepared Excel™ display object and the DB object. The report meta-information includes the DB object, the condition object, and the Excel™ display object. The condition object includes the position of condition object and the row source DB object The Excel™ display object includes the position of the display object and an attribute value of the display object.

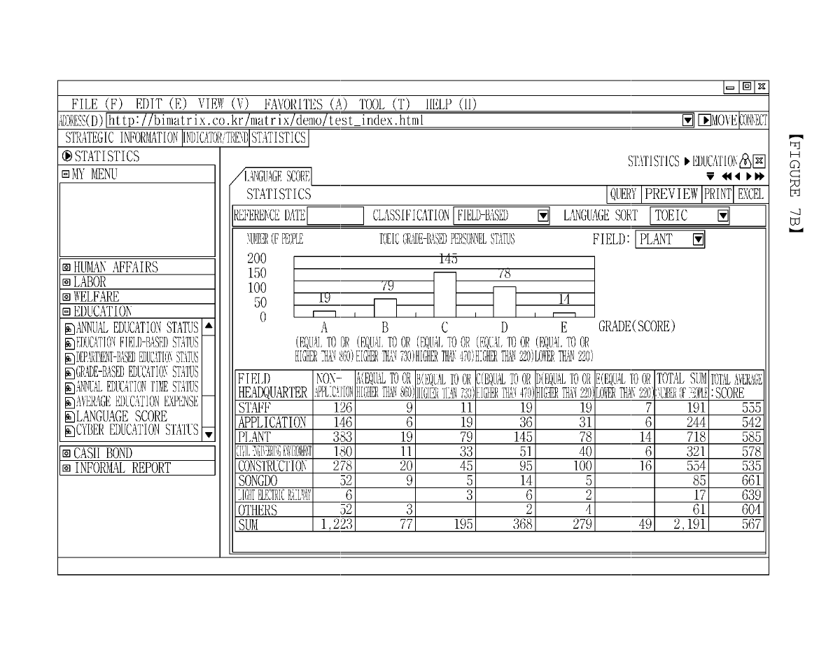

The DB object previously generated by the DB object generating unit 31, the display object prepared by the display object preparing unit 33, etc. are all generated as the report meta-information. As shown in FIG. 7, the report meta-information is shown by the user 21 through the report viewer 50.

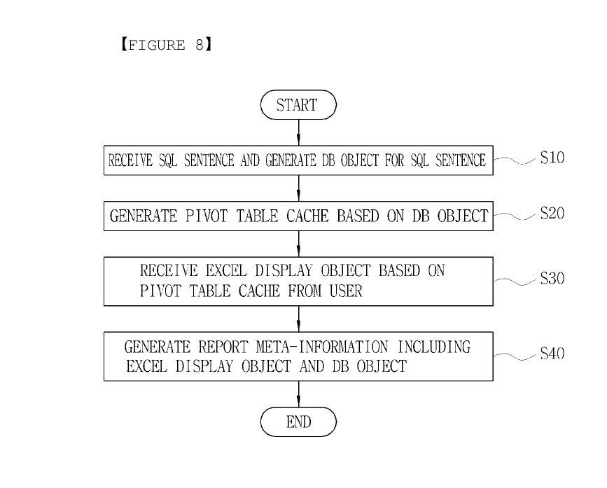

Next, a method for preparing an Excel™-based analysis report in accordance with the embodiment of the invention will be described with reference to FIG. 8.

As shown in FIG. 8, the method comprises: (a) receiving an SQL sentence for querying a DB 80 from a developer, and generating a DB object for the SQL sentence (S10); (b) generating a pivot table cache based on the DB object (S20); (c) generating an Excel™ spreadsheet and receiving an Excel™ display object on the generated Excel™ spreadsheet from the developer, in which data referenced by the Excel™ display object is based on the pivot table cache (S30); and (d) generating report meta-information including the prepared Excel™ display object and the DB object (S40).

Particularly, the DB object includes the SQL sentence and includes the DB table queried by the SQL sentence or a function of querying the SQL sentence.

In step (c), the pivot table and the chart object are prepared as the Excel™ display object. The pivot table is prepared based on the pivot table cache, and the chart object is prepared based on the pivot table.

Moreover, in step (a), the variable value of the SQL sentence of the DB object is determined as the object value of the condition object on the Excel™ spreadsheet, in which the condition object is a cell or a control. The condition object is identified by a name, in which the DB object determines the object value of the cell or the control as a variable value when the variable value of the SQL sentence is the same as the name of the condition object. A row source of the condition object may be composed of the DB object including the SQL sentence. One of data queried by the row source DB object may be selected as the object value of the condition object.

With respect to omissions from the description of the method for preparing an Excel™-based analysis report, the previously given description of the system for preparing an Excel™-based analysis report may be referred to.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

The invention can be applied to the development of a system for preparing a spreadsheet based analysis report, such as a Microsoft Excel™ spreadsheet, which prepares an analysis report or a screen based on the Excel™ spreadsheet by processing basic data stored in a database. Particularly, the invention can be applied to the development of a system for preparing an Excel™-based analysis report, which generate a database (DB) object corresponding to an SQL sentence for querying the database and links the DB object to a pivot table cache of an Excel™ spreadsheet, and supports the preparation of a pivot table or a chart object on the Excel™ spreadsheet based on the pivot table cache.

What is claimed is:

1. A system for preparing an Excel™-based analysis report, which prepares an analysis report presented as an Excel™ display object by processing basic data stored in a database (DB), the system comprising:
a DB object generating unit which receives an SQL sentence for querying the DB from a developer and generates a DB object for the SQL sentence;
a cache-generating unit which generates a pivot table cache based on the DB object;
a display object preparing unit which generates an Excel™ spreadsheet and receives an Excel™ display object on the generated Excel™ spreadsheet from the developer, wherein data referenced by the Excel™ display object is based on the pivot table cache; and
a meta-information generating unit which generates report meta-information including the prepared Excel™ display object and the DB object,
wherein the DB object includes the SQL sentence and includes a DB table queried by the SQL sentence or a function to query the SQL sentence.

2. The system of claim 1, wherein the DB object generating unit provides an SQL generator for querying the DB and receives an SQL sentence generated by the SQL generator.

3. The system of claim 1, wherein the display object preparing unit implements the generation of the Excel™ spreadsheet and the preparation of the Excel™ display object by linking to Excel™ functions.

4. The system of claim 3, wherein the display object preparing unit prepares a pivot table and a chart object as the Excel™ display object, wherein the pivot table is prepared based on the pivot table cache and the chart object is prepared based on the pivot table.

5. The system of claim 1, wherein the DB object queries the database from a DB server connected to a network via a WAS server.

6. The system of claim 1, wherein the DB object generating unit determines a variable value of the SQL sentence of the DB object as an object value of a condition object on the Excel™ spreadsheet, wherein the condition object is a cell or a control.

7. The system of claim 6, wherein the DB object generating unit identifies the condition object by a name, and wherein the DB object determines the object value of the cell or the control as a variable value when the variable value of the SQL sentence is the same as the name of the condition object.

8. The system of claim 7, wherein a row source of the condition object is composed of the DB object including the SQL sentence, and wherein one of data queried by the row source DB object is selected as the object value of the condition object.

9. The system of claim 8, wherein the report meta-information includes the DB object, the condition object, and the Excel™ display object, wherein the condition object includes the position of the condition object and the row source DB object, and wherein the Excel™ display object includes the position of the display object and an attribute value of the display object.

10. A method for preparing an Excel™-based analysis report, which prepares an analysis report presented as an Excel™ display object by processing basic data stored in a database (DB), the method comprising:
(a) receiving an SQL sentence for querying the DB from a developer and generating a DB object for the SQL sentence;
(b) generating a pivot table cache based on the DB object;
(c) generating an Excel™ spreadsheet and receiving an Excel™ display object on the generated Excel™ spreadsheet from the developer, wherein data referenced by the Excel™ display object is based on the pivot table cache; and
(d) generating report meta-information including the prepared Excel™ display object and the DB object,
wherein the DB object includes the SQL sentence and includes a DB table queried by the SQL sentence or a function of querying the SQL sentence.

11. The method of claim 10, wherein, in step (c), a pivot table and a chart object are prepared as the Excel™ display object, wherein the pivot table is prepared based on the pivot table cache and the chart object is prepared based on the pivot table.

12. The method of claim 10, wherein, in step (a), a variable value of the SQL sentence of the DB object is determined as an object value of a condition object on the Excel™ spreadsheet, wherein the condition object is a cell or a control.

13. The method of claim 12, wherein, in step (a), the condition object is identified by a name, and wherein the DB object determines the object value of the cell or the control as a variable value when the variable value of the SQL sentence is the same as the name of the condition object.

14. The method of claim 13, wherein a row source of the condition object is composed of the DB object including the SQL sentence, and wherein one of data queried by the row source DB object is selected as the object value of the condition object.

15. A computer-readable recording storing a program for performing the method of any one of claims 10 to 14 for preparing an Excel™-based analysis report.
